(19) United States
(12) Patent Application Publication
(10) Pub. No.: US 2021/0039229 A1
(43) Pub. Date: Feb. 11, 2021

(54) Irregular shaped device having a drive member

(71) Applicant: Keith Schuster, Chandler, AZ (US)

(72) Inventor: Keith Schuster, Chandler, AZ (US)

(21) Appl. No.: 16/787,636

(22) Filed: Feb. 11, 2020

Related U.S. Application Data
(60) Provisional application No. 62/885,152, filed on Aug. 9, 2019.

(51) Int. Cl. B25B 13/50; F16M 13/02

(52) U.S. Cl. CPC B25B 13/5091; E04B 9/006; F16M 13/02

(57) ABSTRACT

The disclosed invention is a three part assembly comprising a driving member connected to an irregular shape, which is connected to a threaded shaft. The driving member is configured to rotate the irregular shaped device by use of a driving tool, such as a drill or a screwdriver.

The driving tool may be manual, or power driven. To install the assembly into an object, the assembly is rotated about the threaded shaft and the threads screws into the object.

The irregular shape is preferably designed to attach or connect an item to the object. In a preferred embodiment, the shape is a round hook, the object is a ceiling, and the item is a decorative plant. The three part assembly then provides a convenient method to connect a plant to a ceiling.

### CROSS REFERENCE TO RELATED APPLICATIONS

This application claims the benefit of U.S. provisional patent application No. 62/885,152 filed on Aug. 9, 2019. This provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed to an irregular shape that is driven into an object. More particularly, this invention relates to a driving member connected to the irregular shape and a threaded shaft. The irregular shape is useful for connecting other items to the object.

### (2) Description of Related Art

Irregular shaped devices, such as round end screw hooks, are often hard to screw into a wall or ceiling. The irregular shaped device must be grasped by the hand of a user and twisted to screw them into the wall or ceiling. It is difficult to cause the threads to ‘grab’ into various wall objects, such as wood. A pilot hole can be drilled into a wooden all wood to make the step of installing a threaded shaft easier, but this is a multi-step operation.

Accordingly, what is needed is an easier way to rotate the device and screw it into the wall.

### BRIEF SUMMARY OF THE INVENTION

The disclosed invention is a three part assembly comprising a driving member connected to an irregular shape, which is connected to a threaded shaft. The driving member is configured to rotate the irregular shaped device by use of a driving tool, such as a drill or a screwdriver.

The driving tool may be manually driven such as a shaft with handle and a nut socket, but is preferably a rotating power tool such as a drill with a nut socket. To install the assembly into an object, the assembly is rotated about the threaded shaft and the threads screws into the object.

The irregular shape is preferably designed to attach or connect an item to the object. In a preferred embodiment, the shape is a round hook, the object is a ceiling, and the item is a decorative plant. The three part assembly then provides a convenient method to connect a plant to a ceiling.

The foregoing and other features and advantages of the invention will be apparent to those of ordinary skill in the art, when reviewing the description of the invention and the accompanying drawings.

### BRIEF DESCRIPTION OF THE SEVERAL VIEWS OF THE DRAWING(S)

FIG. 1 shows a plan view of an irregular shaped device according to the invention.

FIG. 2 shows a perspective view of an alternate irregular shaped device according to the invention.

FIG. 3 shows a perspective view of another alternate irregular shaped device according to the invention.

FIG. 4 shows a plan view of another alternate irregular shaped device according to the invention.

FIG. 5 shows a perspective view of another alternate irregular shaped device according to the invention.

FIG. 6 shows a preferred embodiment where the irregular shape is installed in a ceiling by a motorized drill.

FIG. 7 shows an alternate embodiment where a manual handle with shaft/nut driver is used to rotate the irregular device.

FIG. 8 shows a plant item that has been hung from the irregular shaped device.

### DETAILED DESCRIPTION OF THE INVENTION

In a preferred embodiment, a round end hook utilizes a nut for the drive member that is attached to the round end portion and the nut center is aligned with a center axis of the threaded shaft which penetrates into a wall or other object when rotated.

As discussed above, embodiments of the present invention relate to the application and formation of a drive member on the center line of an irregular or nonstandard shaped device with a driver. The drive member is configured for the rotation of the irregular shaped device with a driver for driving the device into and/or through an object. The drive member element is configured to removably couple with a drill, for example, and will allow the drill to rotate the device and screw it into a wall, ceiling, door, shelf, wood frame, or other object.

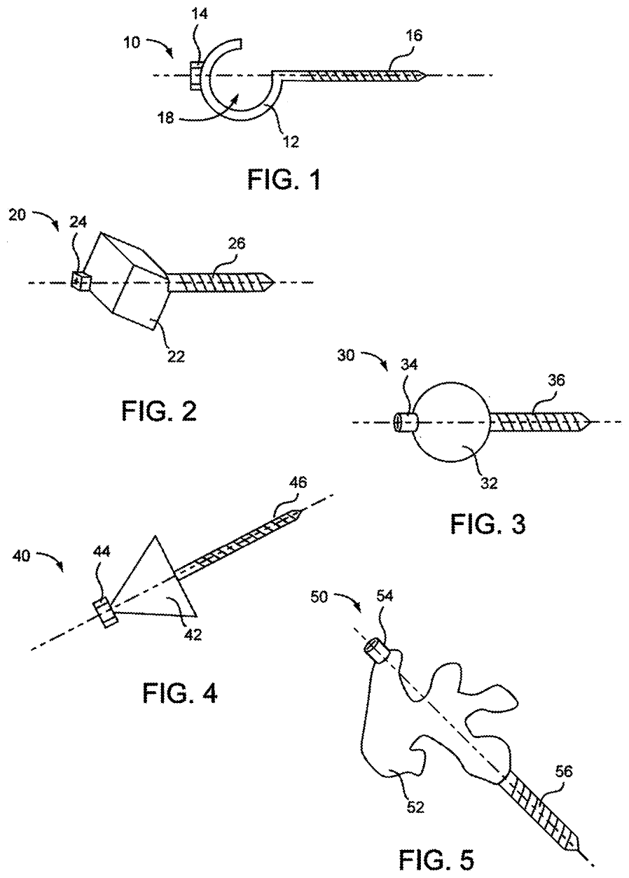

FIGS. 1-5 show an application of a head or drive member aligned with the center axis of an irregular shaped device configured to be driven through an object, such as a wall or ceiling. FIG. 1 shows an irregular shaped device 10 having a round end 12 with an opening 18, the round end 12 having a hexagonal bolt head (drive member) 14 and a threaded portion 16.

As shown in FIG. 2 irregular shaped device 20 has a cubed end 22, the cubed end 22 having a cube bolt head (drive member) 24 and a threaded portion 26. FIG. 3 shows an irregular shaped device 30 having a spherical end 32, the spherical end 32 having a cylindrical head (drive member) 34 with a Philips screwdriver receiver or the like and a threaded portion 36. FIG. 4 shows an irregular shaped device 40 having a pyramidal end 42, the pyramidal end 42 having a hexagonal bolt head (drive member) 44 and a threaded portion 46. FIG. 5 shows an irregular shaped device 50 having an abstract shaped end 52, the abstract shaped end 52 having a spherical bolt head (drive member) 54 with a Philips screwdriver receiver or the like and a threaded portion 56.

As seen in FIGS. 1-6, the drive member is attached to the irregular shaped device and oriented so that torque generated on the drive member causes the threaded shaft to turn. Preferably, the drive member torque axis is substantially aligned to the axis of the threaded shaft. This allows for minimum assembly wobble when installing into an object.

Irregular shaped devices include, but are not limited to, round end screw hooks, such as screw-in cup hooks, screw-in ceiling hooks and screw-in wall hooks.

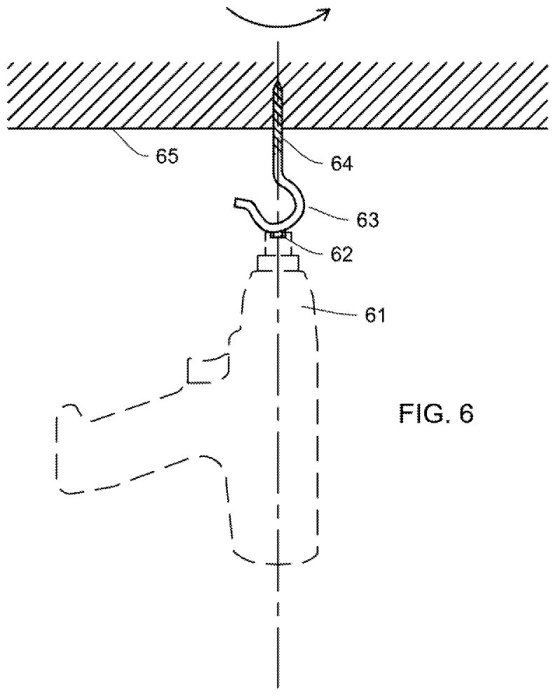

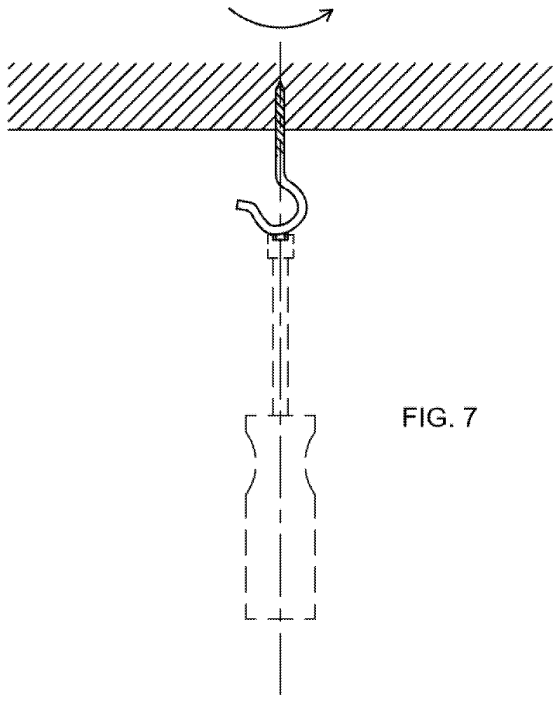

FIG. 6 shows a motorized drill 61 connected to a driving member (hex nut 62) which connects an irregular shape 63 with a threaded shaft 64 into a ceiling 65. The drill has a socket head that fits the driving member. Similarly, FIG. 7 shows a manual handle with a socket head driver for manual rotating.

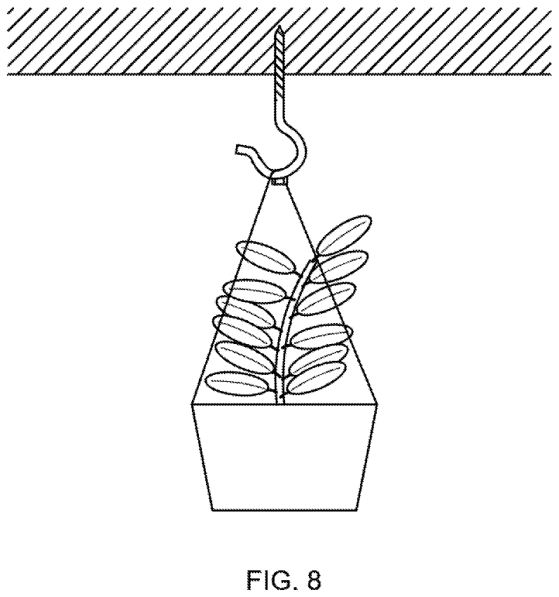

FIG. 8 shows a plant item that has been hung from the irregular shaped device.

Drive members include, but are not limited to, bolt heads, such as hexagonal, button and rounded bolt heads. Also included are screw heads such as slot or Phillip. Power drivers include, but are not limited, to manual drivers, such as a screwdriver, and power tools, such as a drill. The threaded shaft includes various thread types such as English or metric, and fine or course threads. Self-tapping is a preferred embodiment for wood, plastic, plaster, drywall, and metals. hook

Preferred irregular shape devices include, but are not limited to, hooks of various shapes, eyelets, hangers, pegs, wire holders, and connecting elements with attachment features or surfaces.

The components defining any irregular shaped device with a drive member may be formed of any of many different types of materials or combinations thereof that can readily be formed into shaped objects provided that the components selected are consistent with the intended operation of an irregular shaped device with a drive member. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any irregular shaped device with a drive member may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed.

Many modifications and variations are possible in light of the teachings above.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. An attaching assembly comprising:
A) a rotating axis,
B) a connected inline assembly comprising in sequence:
a) a threaded shaft,
b) an irregular shaped device, and
c) a driving member,
C) said threaded shaft aligned with said rotating axis, and
D) said driving member having a torque axis that is oriented and aligned with said rotating axis.

2. The attaching assembly according to claim 1 wherein said irregular shaped device comprises:
A) a hook,
B) an eyelet,
C) a hanger,
D) a peg, or
E) a wire holder.

3. The method of installing an attaching assembly comprising:
A) Providing:
a) a rotating axis,
b) a connected inline assembly comprising in sequence:
i) a threaded shaft,
ii) an irregular shaped device, and
iii) a driving member,
c) said threaded shaft aligned with said rotating axis, and
d) said driving member having a torque axis that is oriented and aligned with said rotating axis.
e) a driving tool removably connected to said drive member,
B) operating said driving tool to rotate said drive member about said rotating axis, and
C) pressing said attaching assembly onto an object,
D) whereby said attaching assembly threads into said object.

4. The attaching assembly according to claim 1 wherein said irregular shaped device comprises:
A) a hook,
B) an eyelet,
C) a hanger,
D) a peg, or
E) a wire holder.
